(19) United States
(12) Patent Application Publication
(10) Pub. No.: US 2015/0231581 A1
(43) Pub. Date: Aug. 20, 2015

(54) PORTABLE MIXER WITH HEIGHT-ADJUSTABLE HANDLE

(71) Applicant: GERMANS BOADA, S.A., Barcelona (Rubi) (ES)

(72) Inventors: Xavier Dalmau Requejo, Barcelona (ES); Carles Gamisans Berenguer, Barcelona (ES)

(21) Appl. No.: 14/411,422

(22) PCT Filed: Jul. 31, 2012
(86) PCT No.: PCT/ES2012/070597

§ 371 Date: Apr. 28, 2015

(51) Int. Cl. B01F 13/00; B01F 15/00

(52) U.S. Cl. CPC B01F 13/002; B01F 15/00538

(57) ABSTRACT

Portable mixer for construction materials, of the type used for mixing various materials and comprising: a supporting housing, an electric motor, a handle for gripping and holding the mixer, and a mixer head provided with a rod for coupling to the electric drive motor. The portable mixer also comprises an outer surface of the housing, on which the handle is mounted in such a way that it can move longitudinally with respect to the geometric axis of the rod of the mixer head, and means for locking the handle on the outer surface of the housing, at a variable height from the mixer head.

Portable mixer for construction materials

### OBJECT OF THE INVENTION

The present invention refers to a portable mixer for construction materials, of the type of used for mixing various materials such as mortars, bonding cement, paints, resins and generally all type of dense pastes and liquids.

The portable mixer has special construction features oriented to permit the regulation in height of the handle so that its user may arrange the handle to the best suited height for holding and handling the portable mixer.

### FIELD OF THE INVENTION

The invention is applicable to the construction sector and particularly to various materials as those above cited.

### BACKGROUND OF THE INVENTION

Presently mixers for construction materials are known which comprise a body holding an electric motor, a handle for holding and handling the mixer and an interchangeable mixer head, which has a rod for coupling to the driving electric motor.

This type of mixers have usually standard sizes and do not take into account how tall are the operator which will use them.

During the operation of this type of mixers, the user must hold the mixer firmly by the handle moving the same so that the mixer head, that rotates by the action of the electric motor, moves within the container which holds the materials to by mixed. Depending on the density and quantity of the material to be mixed, the effort to be carried out by the operator may be considerable, such work being more difficult when the dimensions of the mixer, particularly the height of the mixer are not adequate to the height of the user.

This determines that the taller operators have frequently to lower themselves to carry out the handling of the mixer and that the shorter operators must raise the hands excessively to hold and handle the mixer, both postures being inadequate.

Some manufactures of this type of mixers, in view of the above problem, have chosen for its solution to provide mixing rods of different lengths. However this solution is not economically profitable as the user must purchase different mixing rods of various lengths and on the other side it is not effective as the user generally handles the mixer with the rod already assembled in it independently of being adequate or not to his height. This is due to the fact that in most cases searching for the adequate mixing rod and the substitution of the rod already assembled in the mixer brings about a bigger loss of time than that resulting from the use of the mixer as it is configurated.

Another known intent of solution consists in the use of a system located in the fore part of the mixing rod consisting in an extension which may be regulated at will to change its length.

The applicant does not know of the existence of mixers permitting to effectively solve the above mentioned problem.

### DESCRIPTION OF THE INVENTION

The portable mixer for construction materials of this invention corresponds to the above mentioned type, that is, those used for mixing various materials comprising: a support body, an electric driving motor, a handle for holding and handling the mixer and a mixing head with a bar for coupling to the driving electric motor. The mixer of the invention has constructive peculiarities oriented to change the height of the handle in respect to the mixing head and to establish the fixation of said handle at the desired height depending on the stature of the user and, at the same time, to permit that said operation may be carried out in a fast and easy manner.

To this end an according to the invention, the body supporting the mixer has an external surface on which the handle is assembled with the possibility of longitudinal displacement in respect of the axis of the rod for the mixer head and some means for blocking the handle on the external surface of the body, at a variable height in respect to the mixer head.

With these features, when the user wishes to operate the mixer he can release the blocking means of the handle displacing the same vertically, that is in the longitudinal direction in respect to the external surface of the body of the mixer, to arrange the handle to the height which is more convenient in relation to the height of the operator and operating again the blocking means of the handle to hold the same in the desired position. This operation is specially fast and simple for the user and permits the variation of the height of the handle depending on the height of the operator without the need to provide multiple mixing bars to be used by different operators nor to carry out continuous changes of said bars in the mixer.

According to the invention, the external surface of the body has a portion with constant thickness for the longitudinal displacement of the handle and some planes or longitudinal guides which prevent the relative rotation of the handle in respect to the body. In its turn, the handle has a guiding passage with a cross section which is complementary to the cross section of the external surface of the body, which makes its longitudinal displacement possible to change the height, preventing the rotation of the handle in respect to the body.

In one embodiment of the invention the means for blocking the handle located on the external surface of the body of the mixer have a threaded pressure knob radially assembled in respect to the guide for the handle. Said threaded knob may be arranged in an operative position to exert pressure in a radial direction against the external surface of the body of the mixer, preventing the longitudinal displacement of the handle, and may be also arranged in a idle position in which it is located with a certain separation in respect to the guiding passage, having no action against the external surface of the body of the mixer. This idle position permits the longitudinal displacement of the handle in respect to the body of the mixer.

In one embodiment of the invention, the handle has two ring-like protrusions diametrically opposed in respect to the guiding passage, which form two holding areas for the handle. This permits the user to effectively hold the handle with both hands during the operation of the mixer.

### DESCRIPTION OF THE FIGURES

To complement the description of the invention and with the aim to facilitate the understanding of the features of the same, a set of drawings is attached to this description, as a non limitative example, representing as follows:

FIG. 1 shows a front view of an example of the portable mixer of the invention for construction materials, with a handle arranged in a lower position in respect of the body of the mixer.

FIG. 2 shows a figure similar to FIG. 1 with the handle arranged in a higher position.

FIG. 3 shows a plant view of the handle assembled on the body of the mixer.

FIG. 4 shows a view similar to FIG. 3 in which a part of the handle has been removed to facilitate the observation of the threaded pressure knob.

### PREFERRED EMBODIMENT OF THE INVENTION

The mixer shown in the attached drawings consists of a support body (1), an electric driving motor (2), a handle (3) and a mixer head (4) with a rod (5) for its coupling to the driving electric motor (2).

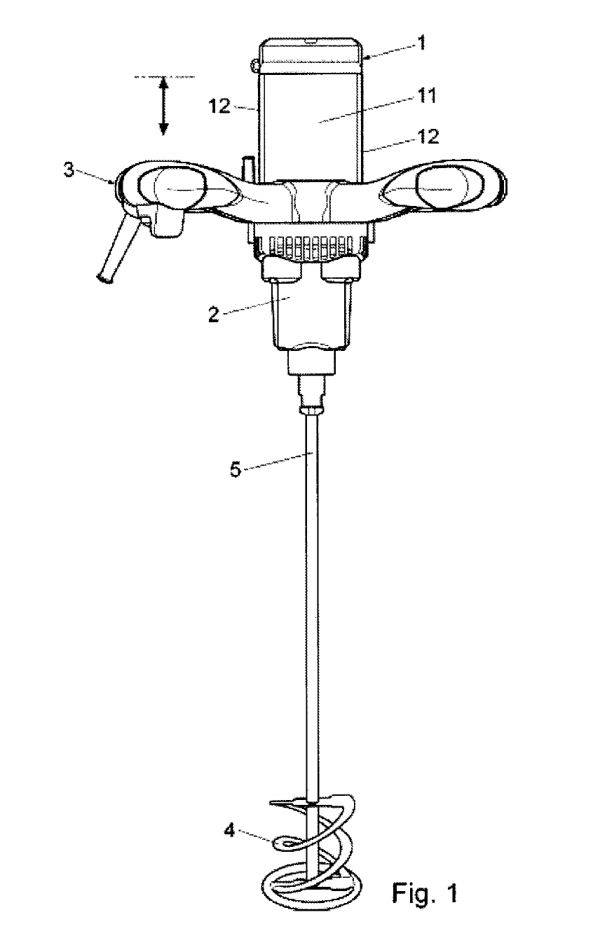

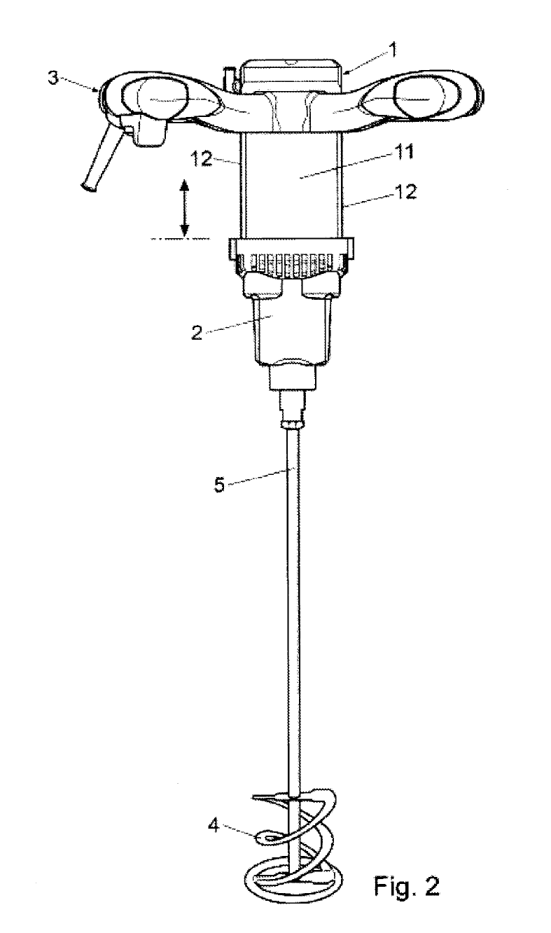

The body (1) has an external surface (11) on which the handle (3) is assembled with the possibility of longitudinal displacement, that is, in the direction of the axis of the rod (5), said handle having the capacity to be located at different heights between a bottom position represented in FIG. 1 and an upper end position shown in FIG. 2.

The external surface (11) of the body of the mixer has a portion with a constant thickness for the longitudinal displacement of the handle (3). In the example being shown said external surface (11) is substantially cylindrical having some diametrically opposed longitudinal planes (12) which prevent the rotation of the handle (3) in respect to the body (1) of the mixer.

In its turn, the handle (3) has internally a guiding passage (31) with a cross section which is complementary to the cross section of the body (1) of the mixer.

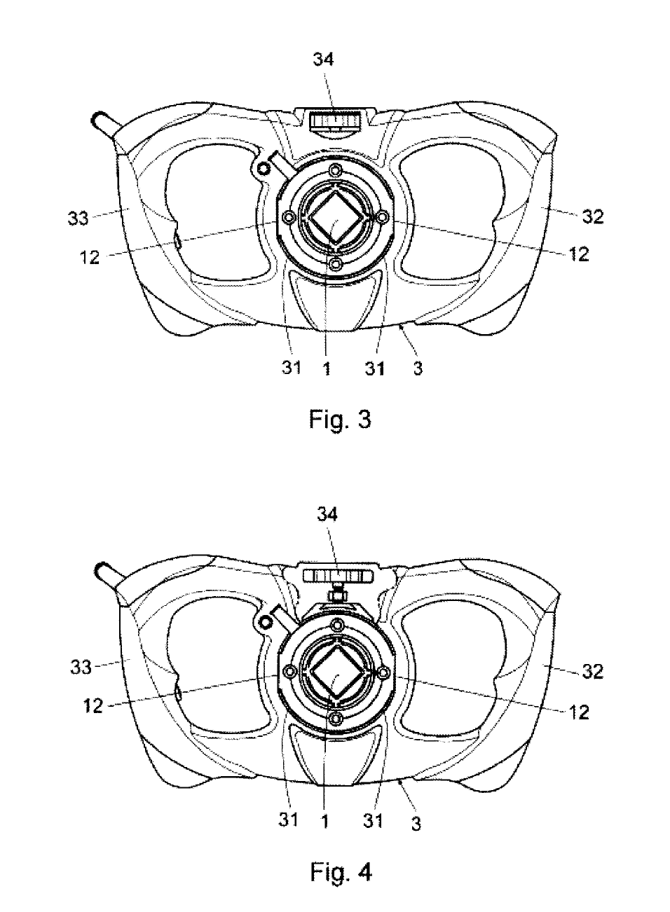

In the example as shown the handle (3) has, as may be observed in FIGS. 3 and 4, two ring-like protrusions (32, 33) diametrically opposed in respect to the guiding passage (31) forming two regions to permit the user to hold the mixer, with both hands.

The means for blocking the handle at different heights in respect to the body (1) of the mixer are shown in FIGS. 3 and 4, having a threaded pressure knob (34) assembled on the handle (3) in a direction which is radial in respect to the guiding passage (31). Sais threaded knob (34) upon being operated in one on another direction of rotation determines the blocking or the release of the handle (3) in respect of the body (1) of the mixer.

Once sufficiently described the nature of the invention as well as an example of a preferred embodiment, it is stated to all effects that the materials, shape, size and arrangement of the described elements may by modified whenever this does not mean an alteration of the essential characteristics of the invention which is claimed as follows.

1. A portable mixer for construction materials of the type used for mixing various materials such as mortars, paints, resins thick pastes, and liquids comprising:
a support body,
an electric motor,
a handle for holding and handling the mixer, and,
a mixing head with a rod for coupling the mixing head to the driving electric motor, wherein the mixer comprises: an external surface of the body on which the handle is assembled with the possibility of displacement and means for blocking the handle on the external surface of the body of the mixer at a variable height in respect to the mixing head, characterized in that the handle is assembled on the external surface of the body of the mixer, with the possibility of linear longitudinal displacement according to the direction of the axis of the rod for coupling the mixing head.

2. The mixer, according to claim 1, characterized in that the external surface of the body of the mixer has a portion with a constant cross section for longitudinal displacement of the handle to prevent rotation of the handle in respect to the body of the mixer whereby said handle has a guiding passage with a cross section complementary to the cross section of the external surface of the body of the mixer.

3. The mixer, according to claim 1, whereby means for blocking the handle on the external surface of the body of the mixer comprises a threaded pressure knob radially assembled on the handle in respect to the guiding passage for the handle.

4. The mixer, according to claim 1, characterized in that the handle has two ring-like protrusions diametrically opposed in respect to the guiding passage forming two portions for holding the handle.

5. The mixer, according to claim 4, characterized in that the handle is assembled on the external surface of the body of the mixer so that the handle may be displaced as a single body, according to a linear longitudinal displacement, without relative movement between said two ring-like protrusions.
